(19) United States
(12) Patent Application Publication
(10) Pub. No.: US 2010/0181448 A1
(43) Pub. Date: Jul. 22, 2010

(54) DISPLAY HAVING SUPPORT STRUCTURE

(75) Inventors: Wen-Hung Huang, Taipei County (TW); Guan-De Liou, Taipei City (TW); Stephen Tsai, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: HANNSPREE, INC., Taipei City (TW)

(21) Appl. No.: 12/719,913

(22) Filed: Mar. 9, 2010

Related U.S. Application Data
(62) Division of application No. 12/276,975, filed on Nov. 24, 2008.

(30) Foreign Application Priority Data
Jul. 4, 2008 (TW) 097125221

(51) Int. Cl. F16M 13/02

(52) U.S. Cl. 248/224.8

(57) ABSTRACT

A support structure for a display device includes a connecting element rotatably connected to the main body, a retractable element rotatably connected to the connecting element and retractable according to the size of the display device, and a supporting element connected to the retractable element and having a hole, wherein the supporting element contacts a surface to support the display device on the surface or to be hung onto a wall by the hole.

### CROSS REFERENCE TO RELATED APPLICATIONS

This application is a division of pending U.S. patent application Ser. No. 12/276,975, filed Nov. 24, 2008, the contents of which are incorporated herein by reference.

### BACKGROUND OF THE INVENTION

1. Field of the Invention

The present invention relates to a support structure for a display, and in particular relates to a support structure supporting a display on a surface or hanging the display on a wall.

2. Description of the Related Art

A conventional support structure of a flat display device or a digital photo frame is disclosed in R.O.C. (Taiwan) patent No. I268413. The support structure is retractable to adjust the height of a display device. U.S. Pat. No. 6,585,201 discloses a universal support structure for a display device. A retractable supporting element is connected to a base via a spherical element, whereby the display device is adjusted in height, and capable of rotating in any direction. U.S. Pat. No. 5,720,465 discloses a reading stand with a retractable supporting element.

For conventional technology, a display device or a digital photo frame can be supported on a surface. When the display device or digital photo frame is hung on a wall, the display device must comprise a hole for attachment.

### BRIEF SUMMARY OF INVENTION

An embodiment of a support structure for a display device of the invention comprises a connecting element rotatably connected to the main body, a retractable element rotatably connected to the connecting element and retractable according to the size of the display device, and a supporting element connected to the retractable element and having a hole, wherein the supporting element contacts a surface to support the display device on the surface or to be hung onto a wall by the hole.

The connecting element is rotatable about a first axis, and the retractable element is rotatable about a second axis perpendicular to the first axis. The supporting element is rotatably connected to the retractable element and is rotatable about a third axis. The third axis is parallel to the second axis.

The retractable element is a linear element with one end rotatably connected to the connecting element and the other end connected to the supporting element.

The supporting element is a flat body having a first surface to which the retractable element is connected, a second surface on which the hole is formed and a third surface contacting the surface.

The first surface is adjacent to the second surface, and the third surface is adjacent to the second surface.

The supporting element is rotatably connected to the retractable element and is rotatable about a third axis.

A detailed description is given in the following embodiments with reference to the accompanying drawings.

### BRIEF DESCRIPTION OF DRAWINGS

The present invention can be more fully understood by reading the subsequent detailed description and examples with references made to the accompanying drawings, wherein:

FIGS. 1 and 2 depict a support structure applied to a display device; and

FIG. 3 is a front view of the support structure of the invention;

FIG. 4 is a schematic view of a display device hung on a wall by the support structure; and

FIG. 5 is a schematic view of another embodiment of the support structure of the invention.

### DETAILED DESCRIPTION OF INVENTION

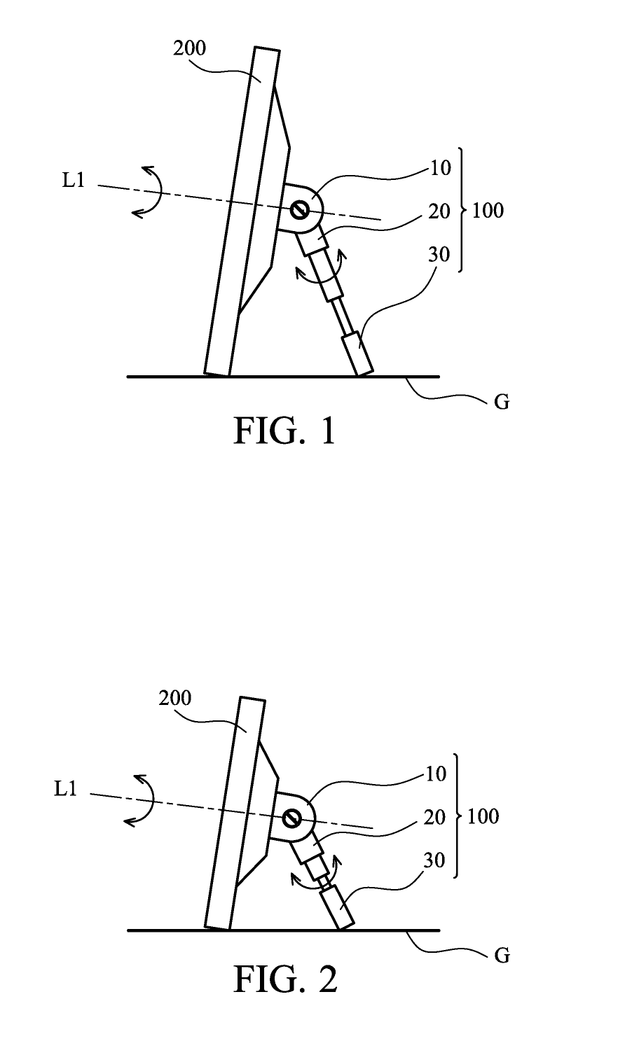

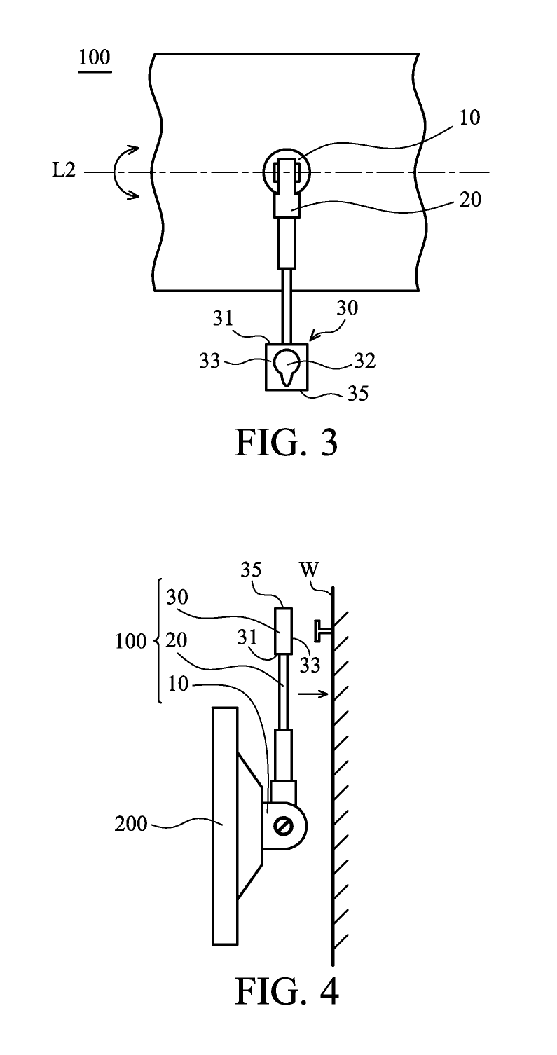

FIGS. 1 and 2 depict a support structure for a flat display device, wherein FIG. 1 shows the display device standing with the long side parallel to the ground, and FIG. 2 shows the display device standing with the short side parallel to the ground. Referring to FIGS. 1 and 2, a support structure 100 is used to support a display device 200 (main body) on a surface G. The support structure 100 comprises a connecting element 10, a retractable element 20 and a supporting element 30. The connecting element 10 is rotatably disposed on the back of the display device 200 and rotates about a first axis L1. The retractable element 20 is a leaner element with one end rotatably connected to the connecting element 10 and rotatable about a second axis L2 (see FIG. 3) and the other end is connected to the supporting element 30. The retractable element 20 is retractable according to requirement.

Referring to FIG. 3, the supporting element 30 is a flat body which has a first surface 31, a second surface 33 and a third surface 35. One end of the retractable element 20 is connected to the first surface 31. A hole 32 is formed on the second surface 33 adjacent to the first surface 31. The hole 32 is a double hole which is used to engage with a hanger to hang the display device on a wall on which the hanger is fixed. The third surface 35 adjacent to the second surface 33 contacts the surface G.

Since the connecting element 10 is rotatably disposed on the back of a display device 200, when the standing condition of the display device 200 is changed, such as changing from a long side standing condition to short side standing condition, the support structure 100 can support the display device 200 via the rotation of the connecting element 10.

In addition, as the retractable element 20 is rotatably connected to the connecting element 10, when the display device 200 is to be hung on a wall W, the retractable element 20 rotates about the second axis L2 to the condition shown in FIG. 4 or rotates about the first axis L1 via the connecting element 10, which adjusts the support structure 100 to be in the condition as shown in FIG. 4.

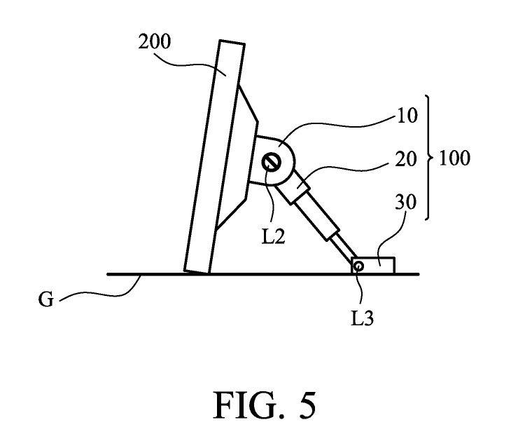

FIG. 5 is another embodiment of the support structure of the invention. The supporting element 30 is rotatably connected to the retractable element 20 and rotates about a third axis L3 which is parallel to the second axis L2. The other structures are the same as the embodiment shown in FIG. 1. In the supporting element 30, the surface contacting the surface G is adjacent to the first surface 31 and opposite to the second surface 33.

The support structure of the invention can support a display device or other electronic devices on a surface G, and can also allow electronic devices to be hung on a wall.

The support structure is not limit to be applied only to display devices. The support structure of the invention can be applied to any device, which requires to be selectively disposed on a surface or to be hung on a wall. The connecting element is not limited to the type shown in the embodiment, as long as the connecting element is rotatably disposed on the device. The retractable element is also not limited to the type shown in embodiment, as long as an element which has enough stiffness and adjustable length is utilized.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A support structure for a device, comprising:
a connecting element rotatably connected to the device;
a retractable element rotatably connected to the connecting element and retractable according to the size of the device; and
a supporting element connected to the retractable element and having a hole, wherein the supporting element contacts a surface to support the device on the surface or to be hung onto a wall by the hole

2. The support structure as claimed in claim 1, wherein the connecting element is rotatable about a first axis, and the retractable element is rotatable about a second axis perpendicular to the first axis.

3. The support structure as claimed in claim 2, wherein the supporting element is rotatably connected to the retractable element and is rotatable about a third axis.

4. The support structure as claimed in claim 3, wherein the third axis is parallel to the second axis.

5. The support structure as claimed in claim 1, wherein the retractable element is a linear element with one end rotatably connected to the connecting element and the other end connected to the supporting element.

6. The support structure as claimed in claim 1, wherein the supporting element is a flat body having a first surface to which the retractable element is connected, a second surface on which the hole is formed and a third surface contacting the surface.

7. The support structure as claimed in claim 6, wherein the first surface is adjacent to the second surface, and the third surface is adjacent to the second surface.

8. The support structure as claimed in claim 1, wherein the supporting element is rotatably connected to the retractable element and is rotatable about a third axis.

9. The support structure as claimed in claim 8, wherein the third axis is parallel to the device.
